(19) United States
(12) Patent Application Publication
(10) Pub. No.: US 2008/0195258 A1
(43) Pub. Date: Aug. 14, 2008

(54) Data Transfer Device For a Bicycle Computer or Similar Computer For a Bicycle Inline Skates Walking Stick or Similar and Method For Setting and/or Updating a Bicycle Computer or Similar

(76) Inventor: Klaus Schendel, Neustadt/Weinstrasse (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/574,459

(22) PCT Filed: Jun. 2, 2006
(86) PCT No.: PCT/DE06/00960

§ 371 Date: Feb. 28, 2007

(30) Foreign Application Priority Data
Jun. 3, 2005 (DE) 10 2005 025 574.4

(51) Int. Cl. G06F 17/00

(52) U.S. Cl. 701/1

(57) ABSTRACT

A data transfer device for a bicycle computer or the like, comprising data transmission means (3), a data processing device for the collection of data according to the selection of a function corresponding to a particular criterion and input of a value, input means (5), selection means (6) and a display device (7). The invention further relates to a computer for a bicycle, inline skates or a walking stick or similar and a method using the data transfer device. An object of the invention is to be able to rapidly set and/or update a bicycle computer according to the requirements of the user. In contrast to the state of the art the bicycle computer (2), or the like, which is difficult to set is not programmed, but rather a data transfer device (1), by means of which the data, after input and selection is then transmitted to the bicycle computer (2), or similar by a contact or by the transceiver principle (8, 9).

### BACKGROUND OF THE INVENTION

The present invention relates to a data transfer device for a bicycle computer or a comparable device, a computer for a bicycle, inline skates, a walking stick, a pulse clock, or a comparable device, where said computer works together with the data transfer device, and a process for initializing and/or updating a bicycle computer or a comparable device by means of the data transfer device.

Bicycle computers, inline skate computers, roller skate computers, or walking stick computers, as well as computers for Nordic walking, or even for a ski pole, are known from practice. Recently, computers have also appeared which receive, compute, and display performance data carried on a neck band or lanyard. The athlete's information concerning the performance she/he has achieved, in particular the distance she/he has traveled and her/his speed, is standard today, even for recreational athletes.

The programming of bicycle computers and the like is difficult due to their compact construction and often can only be achieved with the use of a pointed object for pressing a contact pin countersunk in the housing. Either the vendor of the bicycle computer must perform, in a laborious and boring manner, the basic initialization at the time of purchase while she/he also has to deal with the operating instructions, which are usually extensive, or the user does the tedious work. Still more difficult is the input of pre-existing mileages, or times expended, into a new bicycle computer.

Starting from the state of the art known from practice, the invention is based on the objective of specifying a data transfer device and a bicycle computer, inline skate computer, walking stick computer, or a comparable device working together with the data transfer device, as well as a process using the data transfer device, where the bicycle computer or a comparable device can be initialized and/or updated in a simple and rapid manner and according to the needs of the user.

### SUMMARY OF THE INVENTION

With regard to the data transfer device, the objective above is realized by a data transfer device which comprises data transmission means, a data processing device for collecting data by selecting a function corresponding to a certain criterion and inputting a value, input means, selection means, and a display device.

With regard to a computer which is for a bicycle, inline skates, a walking stick, a Nordic walking pole, a ski pole, or a comparable device and works together with the data transfer device, the objective above is realized by a bicycle computer known from practice, or a comparable device such as an inline skate computer or walking stick computer, which is extended to determine performance data for an athlete with a measurement device, data processing device, and display device by the fact that data transmission means are provided which work together with the data transmission means of the data transfer device according to the invention.

According to the invention it has been recognized that by means of an easily operated data transfer device a simple and rapid initialization of a bicycle computer or a comparable device can be achieved. Via input and selection means, data can be fed into the data processing system which ultimately are transmitted by the data transmission means to the bicycle computer or a comparable device equipped with corresponding data transmission means. Through the data transfer device according to the invention the capability is disclosed of transmitting pre-existing data from one bicycle computer, which is to be discarded, to the new bicycle computer. The miles already traveled, the previous average speed, or the previously [expended] time thus are not lost and can be taken into account in the new bicycle computer. With this, tabulation of an annual performance balance sheet is also possible if the bicycle computer is replaced.

According to a simple and robust form of embodiment, the data transmission means could be formed in the form of two metallic plug-in contacts which work together with the corresponding contact pins of the bicycle computer or a comparable device. Alternatively, it would also be possible to use contact-free technology by means of signal transmission between the data transmission means which is a transmitter and the corresponding receiver of the bicycle computer or comparable device. The bicycle computer, inline skate computer, or walking stick computer therefore comprises for its part data transmission means which correspond to those of the data transfer device. An additional conceivable extension could consist in the fact that a bicycle computer which has already been used or in given cases is to be discarded, or a comparable device, comprises not only a receiver but rather also a transmitter which transmits old data to a receiver in the data transfer device so that it then can be transmitted in a next step to a new bicycle computer or a comparable device.

In order to establish in principle which type of compatible bicycle computer or comparable device is to be initialized or updated, the data processing device of the data transfer device could comprise a storage device which comprises data for the various types of bicycle computers or comparable devices. Via the input means, the vendor or user can input the type of compatible bicycle computer and thus program the data processing device of the data transfer device with regard to the selection of the transmission means appropriate to the particular types of computers.

Similarly to a bicycle computer known per se, the data processing device of the data transfer device could comprise selection means with programmable functions corresponding to certain criteria. The criteria could be the clock time and/or the language which is supposed to appear on the display device. Furthermore, the criterion could be the unit of measurement of the distance, which could be initialized in kilometers or miles. An additional criterion could relate to the speed. In a computer in the form of a pulse clock the criteria could relate to data which relate to body functions such as, for example, heart rate or temperature.

With regard to the updating of a new bicycle computer or a comparable device with the data from a used bicycle computer, which in given cases is to be discarded, or a comparable device, the additional criteria could be an already traveled distance and/or an already expended length of time of athletic activity and/or an average speed. Likewise, in a computer in the form of a pulse clock and ready to be discarded, additional criteria could relate to already available physical data for the athlete. The data already present in the computer to be discarded are fed into the data transfer device in the simplest manner via the data transfer means and transmitted from there to the new computer.

Regarding criteria especially relevant to the bicycle computer, the wheel size could be of importance. Accordingly, the criterion of wheel size could be input in the case of an inline skate computer.

In principle, the data for the selection means corresponding to certain criteria could be programmable via the input means.

With a view to convenient handling, the input means of the data transfer device according to the invention could be in the form of keys which are assigned to certain functions. Coming into consideration are numerical keys for the input of values as well as navigation keys for going to the selection means with various functions and selecting values there. Furthermore, it would be possible to provide an ON and OFF key, a correction key, and a confirmation key for selection or input. The input means could also be realized in the form of a touch screen. Furthermore, the input means could also be in the form of multi-function keys and the input of different data could be accomplished via actuation times of different lengths.

By means of the confirmation key, the feeding of the data relevant to the user into the data processing device could be concluded, where the activation of the data transmission means also takes place. In a particularly preferred form of embodiment of the data transfer device according to the invention the data transmission means of the data transfer device as well as the data transmission means of the compatible bicycle computer or a comparable device could be activated by means of the confirmation key.

Additional functions, which could be comprised in the data processing device of the data transfer device according to the invention, relate to a self-selection function (AUTO MODE) which can be activated, to the automatic display of the fact that batteries must be replaced, and to a radio clock which makes the initialization of the clock time superfluous.

In addition, above all in the case of data transfer devices according to the invention and provided for dealers, a storage location for the purpose of the statistical inclusion of the number of initialized bicycle computers, inline skate computers, Nordic walking computers, or comparable devices could be provided.

According to an additional preferred development of the computer according to the invention and equipped with data transmission means, said computer could be provided with identifying information which is recognized directly by the data transfer device and the query as to the type of computer is initiated automatically within the storage device of the data processing device of the data transfer device. In this way the operation is simplified still further and the vendor no longer has to input the type of the compatible computer into the data transfer device, even one time.

With regard to the computer according to the invention, an additional form of embodiment is provided which relates to the determination, processing, and display of body performance data for an athlete. Therein the computer is a component of a pulse clock. The computer of the pulse clock acts together with measurement sensors. There is, in particular, measurement of the heart rate of the athlete as well as the acquisition, evaluation, and display of the data from the measurement. Also, in the case of pulse clocks a basic initialization, e. g. with regard to the date and the clock time, must be performed by the dealer, said basic initialization being simplified by a computer according to the invention and in the form of a pulse clock working together with a data transfer device according to the invention. Furthermore, there is the possibility, as also in the case of the bicycle computer, inline skate computer, or walking stick computer, of the data transfer means taking over the acquisition of data from a run-down pulse clock and providing a new pulse clock so that body data can be represented continuously and past stages of health can be taken into account in the evaluation. Also, the increase in body performance and the improvement of fitness play an increasing role so that there is a need for this embodiment example as a pulse clock, not only for a dealer but rather also for the athlete her/himself.

The objective formulated in the introduction is furthermore realized by the features of a process for initializing and/or updating a bicycle computer or a comparable device which comprises the following steps.
providing a data transfer device
selection of functions and input of values according to user criteria,
triggering the data transmission from the data transfer device to the bicycle computer or a comparable device,
receiving, internal processing, and display of the initialized and/or updated data on the bicycle computer or a comparable device.

According to the invention it has been recognized, as also with regard to the data transfer device and the compatible computer for a bicycles, inline skates, Nordic walking poles, or comparable devices, that a simplification of the initialization of the same is accomplished by functions being selected on a data transfer device and data being input into them and then an initialization of the bicycle computer being done via the transmission means. This procedure is simpler by far, therefore also executable by a layman, is faster, and is more reliable than the difficult programming of the bicycle computer according to the state of the art. A vendor or user merely has to simply initialize the data relevant to the user [in] the data transfer device, in which the current data, such as clock time and date can already be comprised, and to transmit them. Along with this, there can also be capabilities for corrections as well as the capability of supplying and transmitting old data. Naturally, if the computer comprises no identifying information which automatically initiates the initialization on that type of computer, then manual initialization of the data transfer device is required on that particular type of computer.

The supplying of the old data to the data transfer device can be done without contact via the transmission means in the form of contact pins or via the input means.

In regard to additional advantageous developments of the process according to the invention reference is made to the general description of the data transfer device according to the invention or to the compatible bicycle computers or comparable devices, especially since features are explained there which are also relevant to the process.

There are various possibilities of developing and extending the teaching of the present invention in an advantageous manner. For this, reference is made, on the one hand, to the claims and, on the other hand, to the following explanation of an embodiment example of the invention with the aid of the drawings. In connection with the explanation of the cited embodiment example of the invention with the aid of the drawings, preferred developments and extensions of the teaching are explained in general.

### BRIEF DESCRIPTION OF THE DRAWINGS

FIG. 1 is a schematic block diagram, showing a general arrangement of an embodiment of a data transfer device according to the invention and working together with a bicycle computer,

FIG. 2 is a schematic representation, showing selection and input means as well as a display device of a data transfer device of an embodiment of a data transfer device according to the invention, with

FIG. 2 A showing the selection of the type of bicycle computer,

FIG. 2 B showing the selection of the unit of measurement of length,

FIG. 2 C showing the selection of the wheel size,

FIG. 2 D showing the input of the clock time,

FIG. 2 E showing the selection of whether or not there should be automatic selection (AUTO MODE)—ON/OFF,

FIG. 2 F showing the input of the miles already driven,

FIG. 2 G showing the selection of the confirmation—YES/NO,

FIG. 2 H showing on-going transmission,

FIG. 2 I showing completed transmission.

### DETAILED DESCRIPTION OF THE PREFERRED EMBODIMENTS

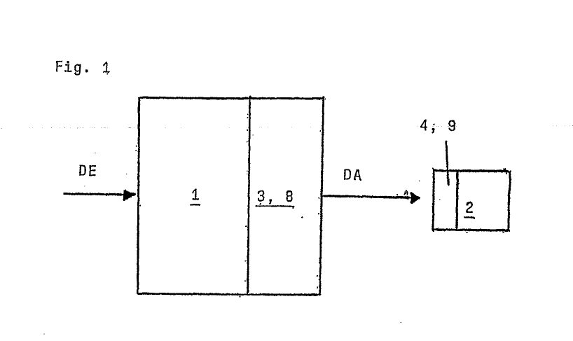

FIG. 1 shows in the form of a schematic block diagram a general arrangement of the system. 1 denotes the data transfer device, 2 a bicycle computer. The data transfer device 1 and the bicycle computer 2 each comprise data transmission means 3, 4 which communicate with one another.

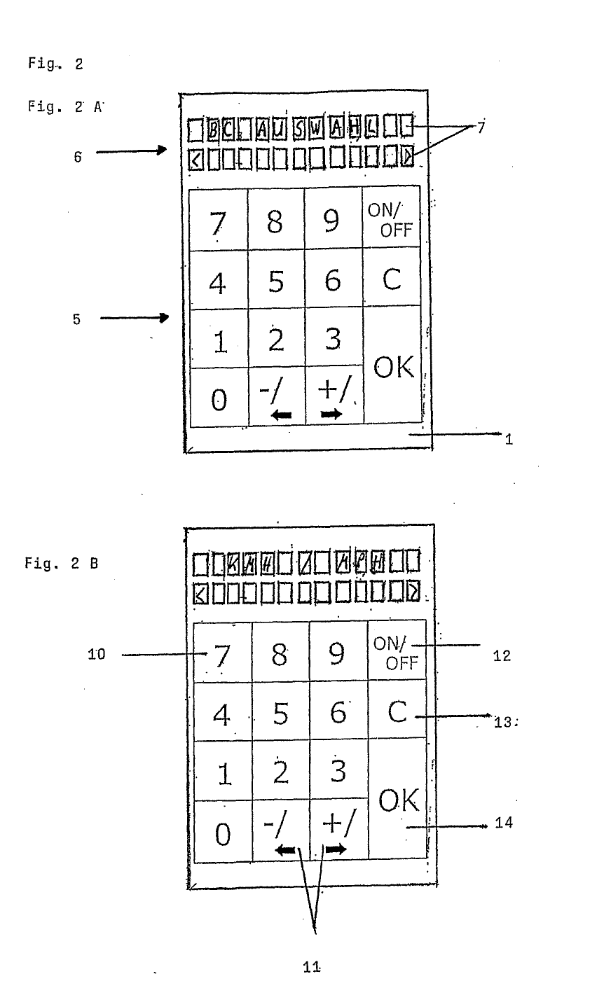

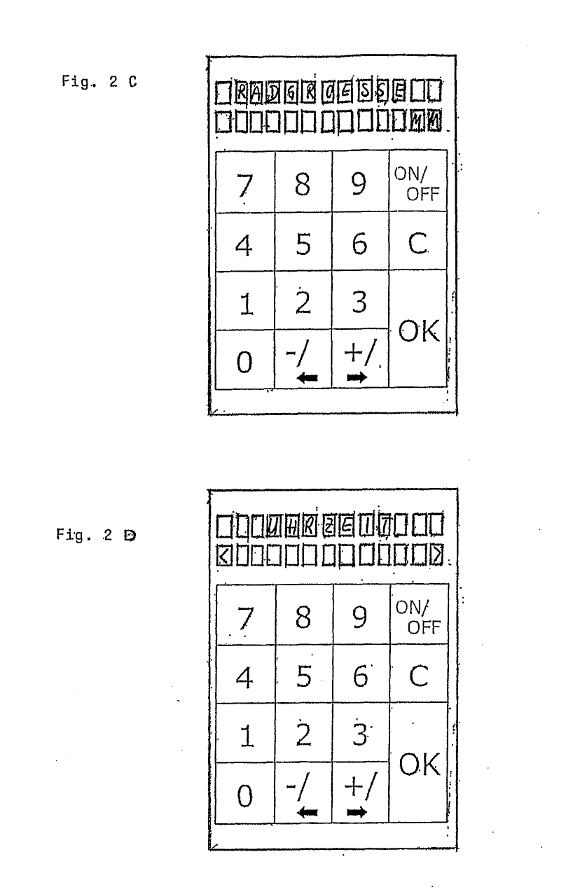

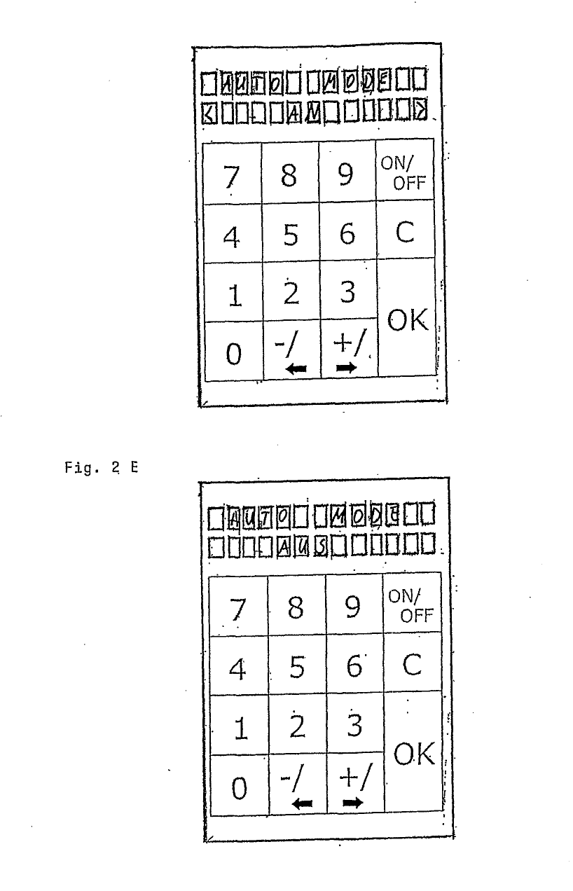

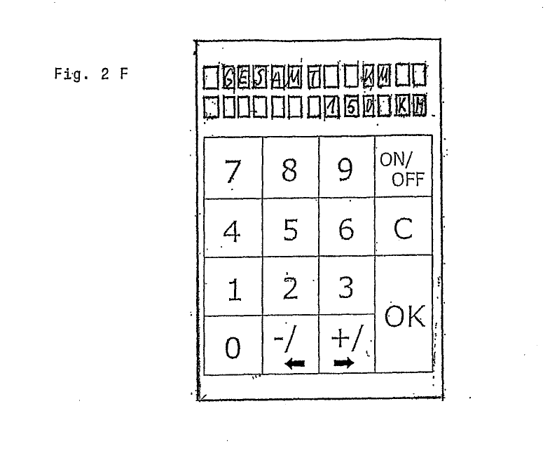

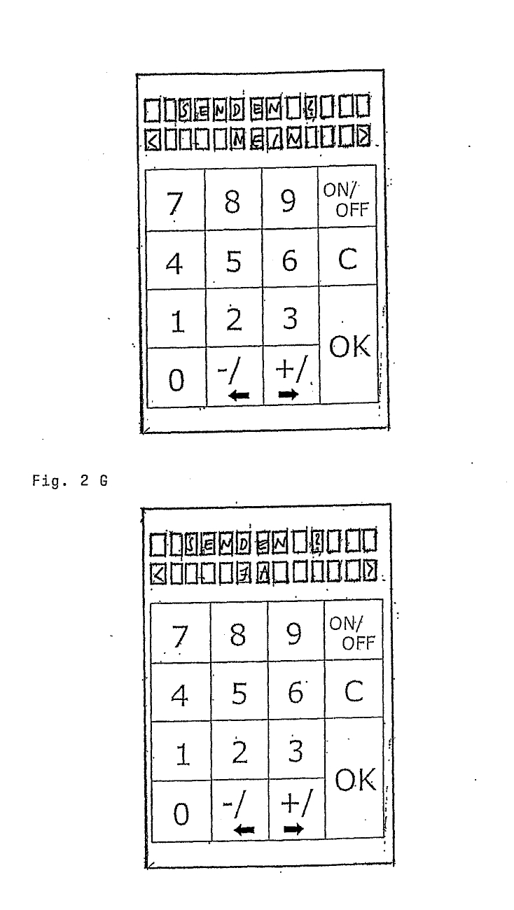

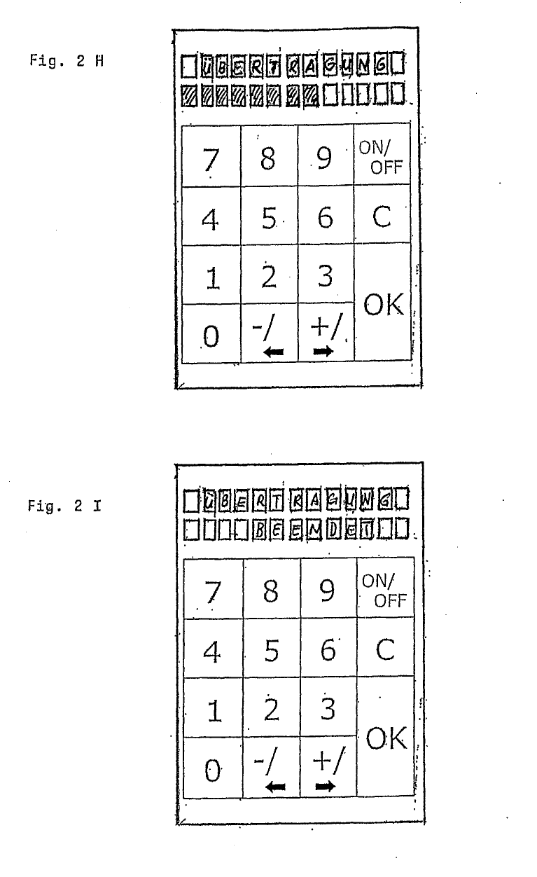

Via the input means 5 represented in FIG. 2 and selection means 6 in the data transfer device 1, data are input into the data transfer device according to the arrow DE shown in FIG. 1.

The data transfer device comprises a data processing device not represented here for collecting data (arrow DE) by selecting a function corresponding to a certain criterion and inputting a value.

Furthermore, the data transfer device comprises a display device 7 shown in FIG. 2.

In the present embodiment example the data transmission means 3 of the data transfer device 1 is formed as a transmitter 8 and the data transmission means 4 of the bicycle computer 2 is formed as a receiver 9. The data are transmitted from the transmitter 8 to the receiver 9 according to the arrow DA. In this way the bicycle computer is provided with the data relevant to the user without transactions having to be carried out in the bicycle computer 2 itself.

The data processing device of the data transfer device 1 comprises, in its storage device, data for different types of the bicycle computers 2. In FIG. 2 A it is shown that the data processing device is programmable, via the input means 5, with regard to the selection of the particular bicycle computer 2. From the programming of the type of bicycle computer it follows that the transmission means 3 appropriate to the particular types of bicycle computers can also be programmed. In the present embodiment example the transmitter 8 is programmed with the input of the type of bicycle computer.

From FIGS. 2 A to 2 I it follows that the selection means 6 of the data transfer device 1 comprise programmable functions corresponding to certain criteria. In FIG. 2 B the selection is done according to the criterion of the unit of measurement of length. Here, it is decided, in accordance with the desire of the user, whether the speed should be specified in kilometers per hour or in miles per hour. FIG. 2 C shows that the criterion of the wheel size corresponding to the wheel size used by the user can be input into the data transfer device 1 via the input means. The criterion of clock time can be programmed according to FIG. 2 D. In the embodiment example shown here there is, in addition, the capability of programming the criterion of a self-selection function (AUTO MODE). In FIGS. 2 E and 2 F the activated ON state and the deactivated OFF state are both shown. Finally, there is still the possibility of carrying out an input of data with regard to the criterion of the distance already traveled. In the present embodiment example the athlete has already traveled 150 km and, according to FIG. 2 G, has input this amount into the data transfer device 1.

If all the data corresponding to the various criteria have been input or selected, there is furthermore the selection function with regard to the transmission of the data to the bicycle computer 2 and according to the arrow DA in FIG. 1. If, for example, an error has occurred, “NO” can be selected according to FIG. 2 H. If the input is correct, “YES” can be selected in order to initiate the data transfer.

The display device 7 of the data transfer device 1 henceforth shows, corresponding to the specifications of the data processing device, information relating to the data transmission. In FIG. 2 H the on-going transmission is shown. There, somewhat more than half of the amount of data has already been transmitted. In FIG. 2 I the transfer process has been completed.

The programming of the data for the selection means 6 corresponding to certain criteria is done via the input means 5.

Among the input means 5 are the numerical keys 10 for the numerical values 0 to 9 for inputting the wheel size, the pre-existing mileage, and the clock time. Furthermore, the input means 5 comprise navigation keys 11 with which, on the one hand, the selection means 6 can be called in the menu of display device 7 and, on the other hand, also values, data, commands can be selected.

Finally, the input means 5 comprise an ON and OFF key 12, a correction key 13 for the correction of errors, and a confirmation key 14 with which the particular input or selection is confirmed. By means of the confirmation key 14 the input of the data relevant to the user into the data processing device can be concluded and the transmitter 8 activated.

In the present embodiment example, upon activation of the transmitter 8 of the data transfer device 1 the receiver 9 of the bicycle computer 2 is also activated.

If the data, input manually here, have arrived at the receiver 9 of the bicycle computer 2, there is internal processing and display of the initialized or updated data.

With regard to additional features not shown in the figures, reference is made to the general part of the description.

In conclusion let it be pointed out that the teaching according to the invention is not restricted to the embodiment example discussed above. Rather, a non-manual data input into the data transfer device and providing other criteria, selection capabilities, and functions is possible. Also, a pre-prepared variant of the data transfer device is possible which already comprises all the possible data relevant to the types of computers for bicycles, inline skates, and walking sticks as well as diverse customary wheel and roller sizes and also the clock time by radio transmission. Finally, the fundamental principle of the data transfer device can also be applied to computers which are in the form of a pulse clock and the data transfer can take place with regard to performance data for an athlete, where said data transfer can relate to body parameters or physical parameters.

1. Data transfer device for a bicycle computer or a comparable device comprising
data transmission means (3),
a data processing device for collecting data by selecting a function corresponding to a certain criterion and inputting a value,
input means (5),
selection means (6), and
a display device (7).

2. Data transfer device according to claim 1, wherein the data transmission means comprises two metallic plug-in contacts which work together with the corresponding contact of the bicycle computer or a comparable device.

3. Data transfer device according to claim 1, wherein the data transmission means (3) comprises a transmitter (8) which transmits the data to a corresponding receiver (9) of the data transmission means (4) of the bicycle computer (2) or a comparable device.

4. Data transfer device according to claim 1, wherein the data processing device comprises a storage device which comprises data for different types of bicycle computers (2) or comparable devices.

5. Data transfer device according to claim 4, wherein the data processing device can, via the input means (5), be programmed for selecting the transmission means (3) relating to the particular type of computer.

6. Data transfer device according to claim 1, wherein the selection means (6) comprise programmable functions corresponding to certain criteria.

7. Data transfer device according to claim 1, wherein the criteria are the clock time and/or the language on the display device (7).

8. Data transfer device according to claim 1, wherein one of said criterion is the unit of measurement of the distance.

9. Data transfer device according to claim 8, wherein the unit of measurement of the distance can be indicated in kilometers or miles.

10. Data transfer device according to claim 1, wherein said criterion is the distance already traveled.

11. Data transfer device according to claim 1, wherein said criterion is the already expended length of time of athletic activity.

12. Data transfer device according to claim 1, wherein said criterion for bicycle computers or inline skates is the wheel size or roller size.

13. Data transfer device according to claim 1, wherein the selection means (6) can be programmed via the input means (5).

14. Data transfer device according to claim 1, wherein the input means (5) comprise numerical keys (10) for the input of values, as well as navigation keys (11) with regard to the selection means (6) with different functions and the selection of values.

15. Data transfer device according to claim 14, wherein the input means (5) comprise an ON and OFF key (12), a correction key (13), and a confirmation key (14) for selecting or inputting.

16. Data transfer device according to claim 15, wherein, by means of the confirmation key (14), inputting the data relevant to the user into the data processing device can be concluded and at least the data transmission means (3) can be activated.

17. Data transfer device according to claim 16, wherein, by means of the confirmation key (14), the data transmission means (3) of the data transfer device (1) as well as the data transmission means (4) of the bicycle computer (2) or a comparable device can be activated.

18. Computer for bicycles, inline skates, walking sticks, or comparable devices for determining performance data for an athlete comprising a measurement device, a data processing device, and a display device, wherein data transmission means (4) are provided which work together with data transmission means (3) of the data transfer device (1) according to claim 1.

19. Computer according to claim 18, wherein the data transmission means (4) comprise a receiver and a transmitter, or are in the form of contact pins.

20. Computer according to claim 18, wherein the identifying information with respect to the type of computer is provided, wherein said identifying information can be recognized by the data transfer device and the qualification of the type of computer is initiated automatically within the storage device of the data processing device of the data transfer device.

21. Computer according to claim 18, wherein the computer is provided within a pulse clock and that the performance data relate to body performance data for an athlete.

22. Process for initializing and/or updating a bicycle computer or a comparable device, said process comprising the following steps:
providing a data transfer device according to claim 1,
selection of functions and input of values according to user criteria,
triggering the data transmission from the data transfer device to the bicycle computer or a comparable device,
receiving, internal processing, and display of the initialized and/or updated data on the bicycle computer or a comparable device.

23. Process according to claim 22, wherein, via the data transfer device, data are taken from an already used bicycle computer or a comparable device and are transferred to another bicycle computer or a comparable device.
